(19) United States
(12) Patent Application Publication
(10) Pub. No.: US 2006/0203010 A1
(43) Pub. Date: Sep. 14, 2006

(54) Real-time rendering of embedded transparent geometry in volumes on commodity graphics processing units

(76) Inventors: Peter Daniel Kirchner, Putnam Valley, NY (US); Christopher Joel Morris, Mount Vernon, NY (US)

Correspondence Address: GEORGE A. WILLINGHAN, III;AUGUST LAW GROUP, LLC, P.O. BOX 19080, BALTIMORE, MD, 21281-9080, US

(21) Appl. No.: 11/079,781

(22) Filed: Mar. 14, 2005

(51) Int. Cl. G09G 5/00

(52) U.S. Cl. 345/629

(57) ABSTRACT

A method for creating composite images of multiple objects using standard commodity graphics cards is provided that eliminates the need for expensive specialty graphics hardware for generating real-time renderings of the composite images. After the desired composite image and the objects contained in the composite image are identified, a volume rendered image of a first object is obtained. In addition, at least a first geometric representation and a second geometric representation of a second object based upon a desired composite image of the first and second objects are generated. These geometric representations are preferably polygonal representations. The volume rendered image and the geometric representations are used to create a plurality of composite image components. Each composite image component contains at least one of the volume rendered image, the first geometric representation and the second geometric representation. The composite image components are blended to create the desired composite image.

### FIELD OF THE INVENTION

The present invention is directed to image rendering.

### BACKGROUND OF THE INVENTION

Direct volume rendering is a visualization technique for three-dimensional (3D) objects that represent various types of data including sampled medical data, oil and gas exploration data and computed finite element models. In the petroleum industry, for example, geophysical data are typically acquired as a volumetric dataset, e.g. an ultrasound volume, and visualization techniques, such as direct volume rendering techniques, are used in order to see multiple components of the dataset simultaneously. In addition, geometric objects, such as oil wells or isosurfaces, i.e. polygonal meshes, that denote important geophysical surfaces, need to be inserted into the same scene containing the volume representation of the geophysical data to highlight relevant features in the volume without completely occluding the volume. Similar rendering needs are found in the medical industry where volume data in the form of three-dimensional CT, MR, or ultrasound data are combined with geometric objects such as surgical instruments, and a rendering of the combination is produced.

In general, direct volume rendering methods are used to visualize volume data. Direct volume rendering, which includes 3D texture mapping among other techniques, refers to rendering techniques that produce projected images, for example two-dimensional (2D) projections, directly from volume data without creating intermediate constructs. In order to compute a 2D projection of a 3D object, optical properties of the 3D object including, for example, how the object generates, reflects, scatters or occludes light, are continuously integrated along logistical rays that are projected from the viewpoint through the body of the volume and form the resulting projected 2D image. The time and processor requirements associated with these integration computations are significant.

Applications utilizing direct volume rendering, however, increasingly require direct volume rendering in real time. For example, during a surgical procedure, a surgeon needs to view a series of 2D projected images as the surgical procedure progresses in real time. In order to attempt volume rendering in real-time, the rate at which the 2D projected images are created, called the interactive frame rate, is important. The significant amount of processing time associated with creating 2D projections using direct volume rendering causes a decrease in frame rates in rendering applications, limiting the widespread application of direct volume rendering in particular to applications requiring real-time rendering.

In addition to just producing projections of a single volume rendered object, there is a need for projections containing a combination of objects. For example, a 3D representation of the geomorphology of a particular region can be combined with a 3D representation of a mine shaft, and 2D projections can be created of this combination. This combination of more than one 3D object requires direct volume rendering techniques that incorporate a first object, e.g. the mine shaft, into a second object, e.g. the geomorphology of the area containing the mine shaft. Previous solutions to the combination of two or more objects directly combined sampled volume data, such as Computerized Tomography (CT) or Magnetic Resonance (MR) images, with polygonally defined geometric objects, for example surgical instruments, probes, catheters, prostheses and landmarks displayed as glyphs. One method for mixing volume and polygonal graphics is described in Kaufman, A., Yagel, R., and Cohen, R., Intermixing Surface and Volume Rendering, 3D Imaging in Medicine: Algorithms, Systems, Applications, Vol. 60, pp. 217-227 (1990). In this method the models are converted into sampled volumes and rendered using a volume rendering technique. In Levoy, M., Efficient Ray Tracing of Volume Data, ACM Trans. on Graphics, 9(3), 245-261 (1990), rays are simultaneously cast through both the volume object and the polygonally defined geometric object. The resulting colors and opacities are composited in depth-sort order. Both of these methods, however, are slow and have significant storage requirements.

The technique of re-rendering volume data offered in Bhalerao, A., Pfister, H., Halle, M., and Kikinis, R., Fast Re-Rendering Of Volume and Surface Graphics By Depth, Color, and Opacity Buffering, Journal of Medical Image Analysis, Vol. 4, # 3, pp. 235-251 (September 2000), stores depth, color and opacity information for each view direction in a specialized depth buffer. Storage in this depth buffer facilitates more rapid re-rendering without the traversal of the entire volume and allows rapid transparency adjustments and color changes of materials. This method, however, produces images having a decreased quality as rendering quality is traded-off against relative storage resources.

In Pfister, H., Hardenbergh, J., Jim Knittel, J., Lauer, H., and Seiler, L., The VolumePro Real-Time Ray-Casting System, Proceedings of SIGGRAPH 199, pp. 251-260, Los Angeles, August 1999, a single-chip real-time volume rendering system is described that implements ray-casting with parallel, slice-by-slice processing. This volume rendering system enables the development of feature-rich, high-performance volume visualization applications. However, application of the system as described is restricted to rectilinear scalar volumes. In addition, perspective projections and intermixing of polygons and volume data are not supported. Current versions of VolumePro graphics boards can support embedded transparent geometry; however, the methods and hardware used are significantly more expensive than commodity graphics cards and are specifically architectured for volume rendering and not for general purposes as are commodity graphics cards.

A shear-image order ray casting method for volume rendering is described in Wu, Y., Bhatia, V., Lauer, H., and Seiler, L., Shear-Image Order Ray Casting Volume Rendering, Proceedings of the 2003 Symposium on Interactive 3D Graphics, pp. 152-182, Monterey, Calif. (2003). This method casts rays directly through the centers of pixels of an image plane. Although this method supports the accurate embedding of polygons, content-based space leaping and ray-per-pixel rendering in perspective projection are difficult to achieve.

Therefore a need still exists for an inexpensive commodity volume rendering system that can incorporate polygonally defined, in particular transparent, defined geometric objects in volume objects in real time to produce images of sufficiently high quality. Adequate systems and methods would produce mixed volume and polygonal graphics in real time without the use of expensive customized hardware and with the hardware and software capabilities of existing computer systems.

### SUMMARY OF THE INVENTION

The present invention is directed to a method for creating composite images of multiple objects, including objects that are potentially transparent, using standard commodity graphics cards, eliminating the need for expensive specialty graphics hardware for generating real-time renderings of the composite images. After the desired composite image and the objects contained in the composite image are identified, a volume rendered image of a first object is obtained. In addition, at least a first geometric representation and a second geometric representation of a second object based upon a desired composite image of the first and second objects are generated. These geometric representations are preferably polygonal representations. The volume rendered image and the geometric representations are used to create a plurality of composite image components. Each composite image component contains at least one of the volume rendered image, the first geometric representation and the second geometric representation. The composite image components are blended to create the desired composite image.

The first and second geometric representations are generated based upon a user-defined frame of reference with respect to the desired composite image and any additional viewing parameters that are identified. Based upon the defined frame of reference, the second object is viewed in a first view direction, and the first geometric representation is generated based upon the first view direction. In addition, the second object is viewed in a second view direction substantially opposite the first view direction, and the second geometric representation is generated based upon the second view direction.

For a composite image containing a first object and a second object, at least three distinct rendered images are created. A first composite image component is created that contains the volume rendered image. A second composite image component is created containing the volume rendered image and at least one of the first and second geometric representations, and the third composite image component is created containing the volume rendered image and at least one of the first and second geometric representations. Each one of the plurality of composite image components can be stored in a distinct storage buffer to facilitate blending, and blending can be accomplished by positioning two or more of the composite image components in a front to back order with respect to each other in accordance with a user-defined frame of reference of the desired composite image. One or more qualities in the volume rendered image, the first geometric representation or the second geometric representation can be adjusted in the blended image in accordance with the desired composite image. These qualities include transparency.

### BRIEF DESCRIPTION OF THE DRAWINGS

FIG. 1 is a flow chart illustrating an embodiment of a method for rendering a composite image in accordance with the present invention;

FIG. 2 is a flow chart illustrating another embodiment of a method for rendering a composite image in accordance with the present invention;

FIG. 3 is a flow chart illustrating an embodiment for creating a plurality of composite image components;

FIG. 4 is a flow chart illustrating an embodiment of blending the plurality of composite image components;

FIG. 5 is a flow chart illustrating an embodiment of mapping the composite image to a two dimensional image frame buffer;

FIG. 6 is a flow chart illustrating another embodiment of a method for rendering a composite image in accordance with the present invention; and

FIG. 7 is a representation of the creation of a composite image of a skull and a sphere using a method in accordance with the present invention.

### DETAILED DESCRIPTION

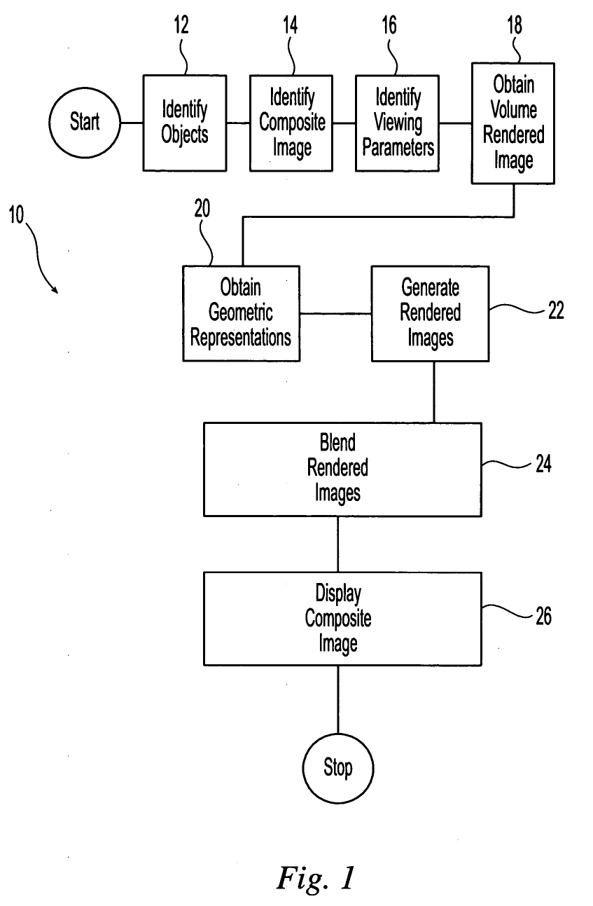

Referring initially to FIG. 1, the present invention is directed to methods for rendering or creating composite images of two or more objects 10. Initially, the desired composite image is identified by a user. In one embodiment, the user identifies the objects that are to be contained in the composite image 12. Each identified object can be any multidimensional, for example three-dimensional (3D), object or representation. Examples of suitable objects include, but are not limited to, geological formations, meteorological conditions or formations, astronomical formations, physical objects, sports equipment, computer equipment, animals, humans, medical devices and equipment, tactical formations and combinations thereof. The identified objects can possess either an inherent or a user-desired interrelation. Examples of these interrelations include the relationship between a section of human anatomy and a surgical instrument, the geomorphology of an area of the Earth and a mine shaft passing through that area of the Earth and a golf club striking a golf ball. In one embodiment, at least two objects are identified, for example a first object and a second object, although any number of desired objects can be identified for inclusion in the composite image. Suitable methods for identifying the objects include, but are not limited to, selecting the objects from a list or database of predefined objects.

After the objects to be included in the composite image are identified, the desired composite image itself is identified 14. Alternatively, a plurality of composite images containing the identified objects is identified. In one embodiment, each composite image contains at least two of the identified objects. Alternatively, each composite image contains three or more of the identified objects. In one embodiment, all of the identified objects are contained in a single composite image. Alternatively, the identified objects can be combined into a plurality of composite images, each composite image containing a distinct combination or composition of identified objects. In addition to identifying the objects to be included in each composite image, the positioning of the objects with respect to each other are also illustrated. Examples of the illustrated positioning include, but are not limited to, placing one object in front of another, placing objects in contact with each other and inserting one object, either fully or partially, into another object. Sufficient positioning detail is provided to indicate composite image qualities including depth of insertion, location of insertion, the contact area of each object, and portions of each object that are obscured by another object from view.

In one embodiment, for each identified composite image, a first object within the composite image is designated to be the main object or scene object. The others objects, for example a second object for a two object composite image, within the composite image are treated as being disposed or inserted in the scene object. For example, a human body and a surgical scalpel are identified objects in a composite image illustrating a surgical procedure. The human body is the first object or scene object, and the scalpel is the second object that is inserted into the patient's body in accordance with the surgical procedure. The composite image is selected to illustrate the relationship between the scalpel and the human body, or an organ within the human body, during the surgical procedure. Additional objects, for example other surgical instruments such as retractors and an artificial hip can also be included in the composite image. Any given object can be treated as either a scene object or an inserted object, and objects do not have to be inherently scene objects. The first object can be identified as the scene object in a first image composition and as an inserted object in a second image composition. For example, an elevator shaft is treated as a scene object containing an elevator car as the second object in a first image composition. In a second image composition, the first object is a building and the elevator shaft is the second object disposed in the building.

Having identified the composite images and the objects contained within the composite images, the parameters for viewing the composite images are identified 16. The viewing parameters include the frame of reference to be used when viewing the composite image. The frame of reference includes, but is not limited to, an indication of the angle of viewing with respect to each object, the distance from the composite image to be used for viewing, whether the composite image is to be viewed from the outside looking in or the inside looking out, the relative transparency of each object, the color of each object, the existence of any cutaway or cross-sectional views, the desired resolution of any features in the objects, any distortions of any of the features of the objects and combinations thereof. The viewing parameters can be user-defined or can be inherent qualities of the composite image or objects contained within the composite image, for example color.

In an example where the identified composite image is used as a surgical aid or in a virtual surgery demonstration, the first object is a 3D Computerized Tomography (CT) image, and medical instruments, prosthetic devices and feature markers are identified as second objects inserted into the first object to form one or more composite images. Different composite images can be identified that contain varying combinations of the first and second objects. Alternatively, a single composition is identified, and a plurality of distinct viewpoints or frame of references can be identified. Given the identified composite images, the user identifies viewing parameters depending on the objectives of the procedure. In addition, any overlapping of the objects based upon the selected frame of reference and viewing parameters are identified. For example, the medical instruments and prosthetic devices can completely or partially obscure each other and portions of the CT image. In addition, the user can change transparency and position of the overlapping objects to emphasize areas in the volume relevant to the procedure. The color of various feature markers can be varied for feature makers having the same general shape and size, providing a more easily recognizable distinction among the various feature markers.

Having identified the composite images, the objects contained in the composite images and the desired viewing parameters, appropriate representations of all of the objects in the composite images are obtained for use in accordance with the present invention. A volume rendered image of each first object is obtained 18. In one embodiment, the volume rendered image of the first object is obtained using a suitable rendering visualization technique for 3D objects. Suitable rendering techniques include 3D texture mapping.

In addition, geometric representations of each second object are obtained or generated 20. The geometric representations are generated based upon the identified composite image and viewing parameters. For example, if the composite image and frame of reference yield a side view of the second object, then the geometric representations are of a side view. Suitable geometric representations include, but are not limited to, basic points, lines, segments, and planes; triangles, tetrahedrons, polygons and polyhedrons; parametric curves and surfaces; spatial partitions, planar graphs and linked edge lists. Preferably, the geometric representations are polygonal representations.

A suitable number of geometric representations for each second object are generated to properly illustrate the desired features in the composite image. Preferably at least two geometric representations, a first geometric representation and a second geometric representation, are generated for each second object in a given composite image. In one embodiment, the composite image is viewed within the user-defined frame of reference in a first view direction to generate a first geometric representation. The composite image is then viewed within the user-defined frame of reference in a second view direction distinct from the first view direction to generate the second geometric representation. Preferably, the second view direction is substantially opposite, for example about 180° opposed, the first view direction although other angles of off-set can be used, such as angles other than 180° or slight variations from 180°. In an embodiment where the geometric representations are polygonal representations, the first geometric representation contains front-facing polygons of the second object, and the second geometric representation comprises back-facing polygons of the second object. The determination of whether the polygonal representation is front-facing or back-facing depends on the sign of the polygon's area, computed in window coordinates, or the direction of the polygon's normal vector.

The volume rendered image and the geometric representations are used to create a plurality of composite image components 22. Each composite image component includes at least one of the volume rendered image, the first geometric representation and the second geometric representation. In one embodiment, three composite image components are generated for each combination of a first volume rendered object and a second object. These three composite image components include a first composite image component containing the volume rendered image, a second composite image component containing the volume rendered image and at least one of the first and second geometric representations and a third composite image component containing the volume rendered image and at least one of the first and second geometric representations. In one embodiment, the second composite image components contains the volume rendered image and the first geometric representation, and the third composite image component contains the volume rendered image and the second geometric representation. For composite images containing more than one second object, additional composite image components are produced containing the volume rendered object and each one of the geometric representations of the additional second objects. For example, if one additional second object is in the composite image and two geometric representations have been generated for this additional second object, then two additional composite image components are generated, one each for the combination of geometric representations and volume rendered object. A duplicate composite image component containing just the first object does not have to be generated. All of the composite image components are generated in accordance with the identified composite image and viewing parameters.

In one embodiment, the composite image components are created by rendering the selected geometric representation and the volume image using compositing techniques that provide for hidden-surface removal to exclude contributions from portions of the volume image or geometric representations that are obscured from view as indicated by the viewing parameters. Preferably, these compositing techniques include the use of depth testing and z-buffers, where z refers to an axis corresponding to the direction along which the composite image is being viewed.

In general, depth testing determines if a portion of one object to be drawn is in front of or behind a corresponding portion of another object. This functionality can be provided through the program language used to create the composite image components. Preferably, the programming language is the OpenGL programming language. OpenGL, which stands for Open Graphics Library, is a software interface to graphics hardware that allows a programmer to specify the objects and operations involved in producing high-quality graphical images. In order to determine if one object is located in front of or behind another object, a depth buffer or z-buffer is created for storing depth information or depth values for various portions of these objects as relates to the location of these objects along a z-axis, which is an axis running in the direction along which the composite image is being viewed. Therefore, the depth values provide a measure of the distance from various portions of the objects to the user viewing the composite image. In one embodiment, a single z-buffer is created to store all of the depth values for all objects contained in the composite image. In another embodiment, a separate z-buffer is created for each frame buffer.

In one embodiment, the geometric representations, for example the polygonal geometric objects, are rendered with the depth test enabled such that the depth values associated with the second object are stored in the depth buffer. Each stored geometric representation image depth value is associated with a distinct portion of the geometric representation of the second object as viewed with respect to the user-defined frame of reference. In one embodiment, the depth buffer is set to a read-only mode after the depth values of the geometric representations have been entered. When the volume rendered image of the first object is generated, depth values associated with each of a plurality of portions of the first object are generated. The depth values associated with the volume rendered image are tested against the stored depth values associated with the geometric representation of the second object to determine the order of or depth of various portions of the first and second objects along the depth axis. This comparison is used to facilitate mixing or blending of the volume rendered image with the geometric representations. Suitable blending techniques include alpha blending. In one embodiment, alpha blending is conducted on a pixel-by-pixel basis. For example, if a comparison of the depth values indicates that a portion of the volume object is located “in front” of the second object, this portion of the volume rendered image is blended with the corresponding portion of the geometric representation of the second object.

In general, the geometric representation depth values associated with portions of the second object corresponding to portions of the volume rendered image in accordance with the user-defined frame of reference are compared. This comparison is used to determine the relative location of corresponding portions of the first and second objects along the direction of viewing. For example, when comparing depth values associated with corresponding portions of the first and second objects, the object having the lower associated depth value, i.e. the portions of the closer object, can be included in the composite image components or composite image, and the portions of the farther object can be discarded from the composite image components of composite image. Alternatively, the corresponding portions of the first and second objects and in particular corresponding portions of the volume rendered image and geometric representations can be blended together in accordance with the associated depth values. In one embodiment where blending of the images is used, the depth values in the depth buffer are treated as read only. Alternatively, when the closest portions are used and the farther portions are discarded or not included in the composite image, depth values in the depth buffer can be changed so that the depth values associated with the closest portion are retained in the depth buffer.

In addition to creating the composite image components and performing hidden surface removal, the plurality of composite image components are blended to create the user-defined desired composite image 24. Blending includes, but is not limited to, compositing a plurality of composite image components in front of each other and rendering them into the single composite image. In one embodiment, composite image components are blended by positioning two or more of the composite image components in a front-to-back or front-to-back order with respect to each other in accordance with the user-defined frame of reference of the desired composite image. For example, the composite image component containing the volume object and the second geometric representation of the second object is positioned in front of the composite image component containing only the volume rendered image and blended to produce an interim image. The composite image component containing the volume object and first geometric representation of the second object is positioned in front of the interim image and blended to produce the user-defined composite image, which contains a desired combination of the first and second objects.

In order to provide for the blending of the composite image components, each composite image component is preferably stored in a distinct storage buffer. In one embodiment, each composite image component is stored in a buffer residing on a standard computer graphics card. Alternatively, each composite image component can be stored in a buffer that resides in the main memory of the central processing unit (CPU) used to created the renderings and to execute methods in accordance with the present invention. Therefore, specialized graphics cards and memory locations are not required to produce composite images in accordance with the present invention.

If desired or necessary, one or more qualities in the volume rendered image, the first geometric representation or the second geometric representation in the composite image components can be adjusted in accordance with the desired composite image and the identified viewing parameters. For example, compositing techniques, such as depth testing using OpenGL, are used not only to perform hidden surface removal but to blend the composite image components in accordance with image qualities of the composite image components such as transparency.

In one embodiment, the geometric representations are rendered and the geometric representation depth values associated with the second object are stored in a read-only depth buffer. Each geometric representation depth value is associated with a distinct portion of either the first geometric representation or the second geometric representation as viewed with respect to a user-defined frame of reference. The volume image of the first object is rendered, preferably using 3D texture mapping. The volume image depth values associated with portions of the first object that, in accordance with the user-defined viewpoint, correspond to portions of the second object are compared to determine the relative depths of these corresponding portions of the first and second objects. Therefore, a determination can be made about whether or not a volume image portion is located in front of or behind the geometric representation portions.

Since the depth buffer is read-only, the depth values in the depth buffer cannot be changed. Therefore, instead of eliminating the objects in the frame buffer that are disposed behind other objects, the corresponding portions of the first and second objects in accordance with the relative depths and image qualities associated with at least one of the volume rendered image are blended together. Preferably, alpha blending is used to blend corresponding and overlapping portions of the first and second objects at the pixel level. Alpha blending refers to a convex combination, or linear combination of data points, that facilitates effects such transparency effects.

The blended image, representing the desired composite image as identified by the user is displayed 26. The blended composite image is displayed on any suitable display medium viewable by the user including computer screens and computer print-outs. In one embodiment displaying the composite image includes rendering the composite image to a frame buffer that encompasses substantially the entire space on the display screen and displaying a correspondingly scaled composite image on that screen. Alternatively, the resulting composite image is stored on a computer readable medium, for example a computer hard drive, for use at a later time, or is copied to a computer for display on that computer's monitor. Methods and systems in accordance with the present invention facilitate applications such as virtual surgery or computer-aided design/computer-aided manufacturing (CAD/CAM) where the geometric models represent mechanical objects or devices as synthetically created polygonal objects, i.e. CAD/CAM models, the volume object represents engineering data and a user wants to interact with both geometric objects and the volume objects in real time while observing the composite image on the computer monitor.

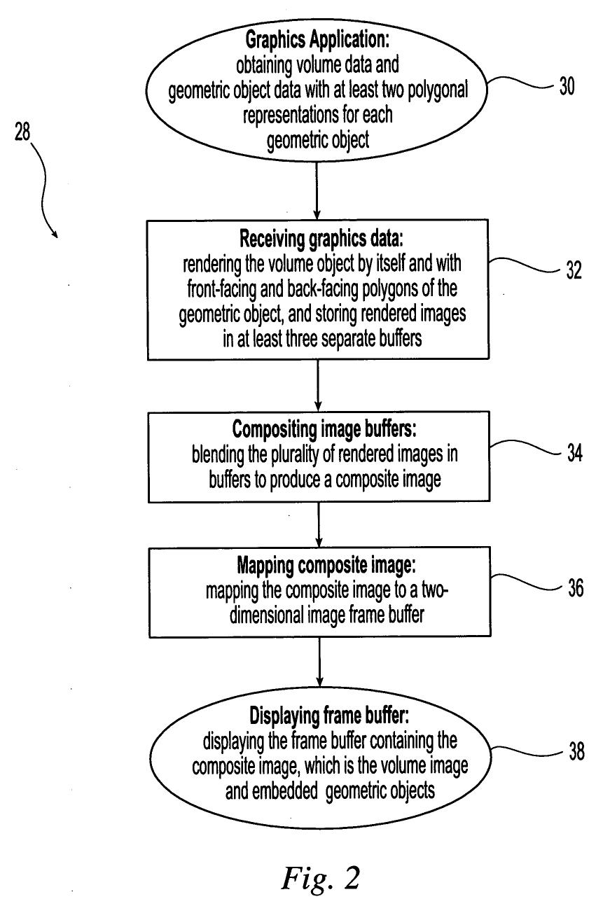

Referring to FIG. 2, an embodiment of a method for direct volume rendering with embedded geometric objects in accordance with the present invention is illustrated 28. In this embodiment the first object is identified as a volume object, and second objects embedded in the volume are transparent geometric objects represented by polygons. Each geometric object in this embodiment is represented by front-facing and back-facing polygons. Following identification of the objects including obtaining the volume and geometric data 30, the volume object is rendered by itself, with the front-facing polygons of the polygonal representation of the second object and with the back-facing polygons of the second object, and these three rendered composite image components are stored in three separate buffers 32. In order to composite the contents of these three separate buffers into the desired composite image, the composite image components are blended to produce a composite image 34, and the resulting composite image is mapped to two-dimensional image frame buffer 36. The resulting composite image is read from the image frame buffer and is displayed 38.

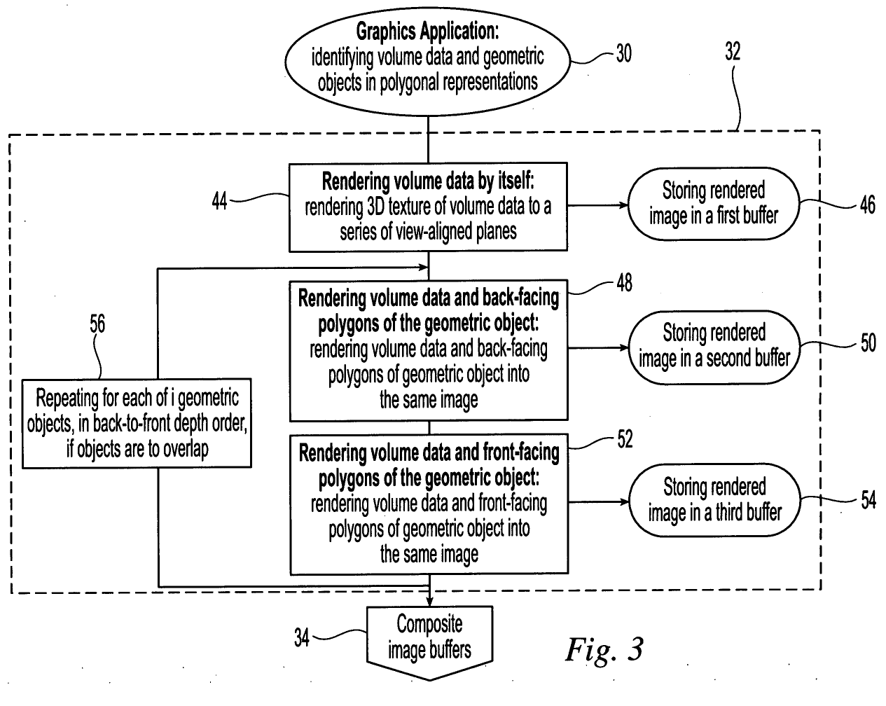

Referring to FIG. 3, an embodiment for receiving the graphics data and producing the desired composite image components 32 is illustrated. After the volume data and polygonal representations are identified and obtained 30, the first object or volume object is rendered by itself 44, for example using 3D Texture Mapping, which is a technique to improve the appearance of rendered objects. In 3D texture mapping, a volume object is defined as 3D-texture. Using the 3D-texture coordinates, an appropriate number of texture slices perpendicular to given viewing direction are cut out of the texture cube. The texture slices are composited in back-to-front manner to render an image containing a two-dimensional array of pixels. The rendered volume image is stored in a first buffer 46, for example denoted first_buffer.

Following rendering the volume object by itself, the volume object is rendered with the back-facing polygons of the geometric object 48. Preferably, the volume object and back-facing polygons are simultaneously rendered into the same image and are correctly ordered along the depth axis. The resulting rendered image is stored in a second buffer 50, for example denoted second_buffer_i. In addition, the volume object and front-facing polygons of the geometric object are rendered into the same image 52 and stored in a third buffer 54, for example designated third_buffer_i.

If there are no more second objects in the composite image, then the process proceeds to compositing the rendered images or composite image components stored in the buffers 34. Alternatively, the process of rendering is completed if there are more than one second objects but the objects do not overlap in the composite image. Multiple non-overlapping second objects in a composite image can be treated as a single second object for purposes of creating the composite image components. If the multiple second objects overlap in the composite image, the procedure of rendering the volume object and back- and front-facing polygons is repeated for each of i overlapping geometric objects 56, preferably in back-to-front depth order. The resulting composite image components are stored in appropriately designated second and third buffers, for example second_buffer_1, second_buffer_2, second_buffer_3, . . . second_buffer_i and third_buffer_1, third_buffer_2, third buffer_3, . . . , third buffer_i.

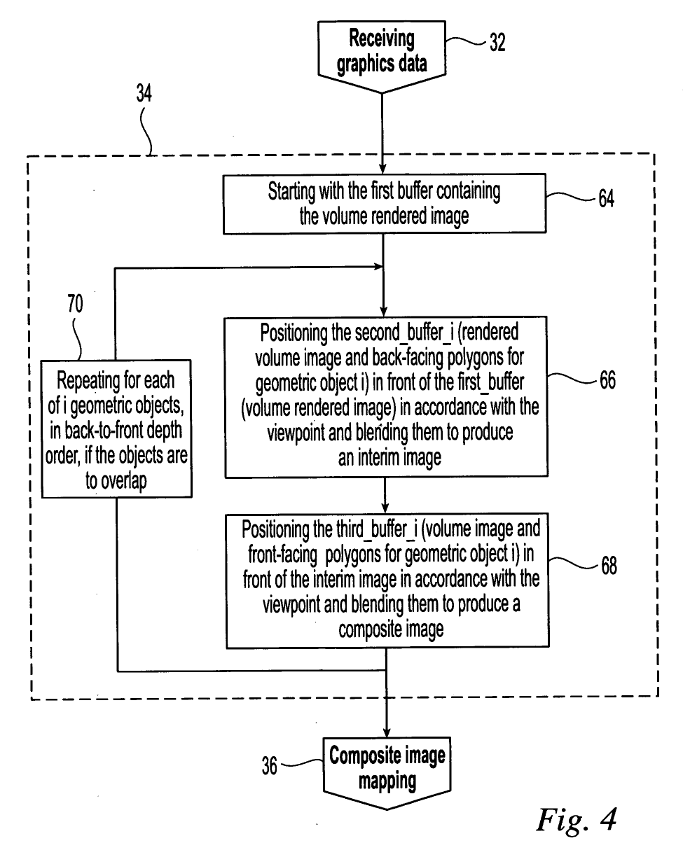

Referring to FIG. 4, an embodiment of a method for compositing the contents of the rendered image buffers 34 is illustrated. In general, the composite image components stored in the first buffer, second buffer and third buffer are blended into a single composite image. In the embodiment as illustrated, the process begins with the volume rendered image contained in the first buffer 64 and blending is performed in two stages. In the first stage the image contained in the second buffer image is positioned in front of the volume rendered image, and the two images are blended to produce an interim image 66.

Preferably, the images are blended using alpha blending with a constant alpha value for each pixel in the second buffer. Alpha blending is a rendering technique for overlapping objects that include an alpha value. In graphics, a portion of each pixel's data is reserved for transparency information. In 32-bit graphics systems, the data are divided among four color channels, e.g. three 8-bit channels each for red, green, and blue, and one 8-bit alpha channel. The alpha channel is a mask that specifies how the pixel's colors are merged with another pixel when the two are overlaid, one on top of the other. This merging includes defining the relative transparencies of each layer. The levels of transparency are varied depending on how much of the background is wanted to show through.

In the second stage of the blending procedure, the composite image component in the third buffer is placed in front of the interim image, and the two images are blended into the desired composite image 68. Preferably, the two images are blended using alpha blending with a constant alpha value for each pixel in the third buffer. In this embodiment the composite image is a two-dimensional and transparent polygonal plane.

The blending of image buffer data is complete if there is just one geometric object in the composite image scene or if two or more geometric objects in the composite image do not overlap. If two or more second objects are contained in the composite image and the second objects overlap, the blending procedure of compositing second buffer images in front of the first buffer image to produce an interim image and compositing third buffer i images in front of the interim image to produce the composite image is repeated for each of i overlapping geometric objects in back-to-front depth order 70.

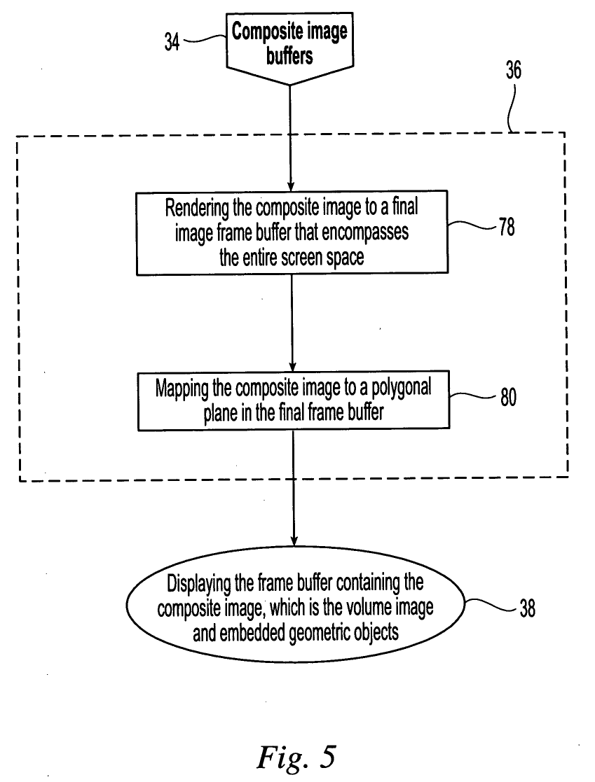

Referring to FIG. 5, an embodiment of mapping the composite image into a two-dimensional image frame buffer 36 is illustrated. In this embodiment, the mapping process includes rendering the composite image to an image frame buffer that encompasses the entire screen space and that contains a normal vector that is parallel to the view direction 78 through which the composite image is to be viewed as defined in the viewing parameters. The rendered composite image is then mapped to a polygonal plane 80 located in the final frame buffer. Again, the image frame buffer containing the composite image is displayed 38, for example on a computer monitor.

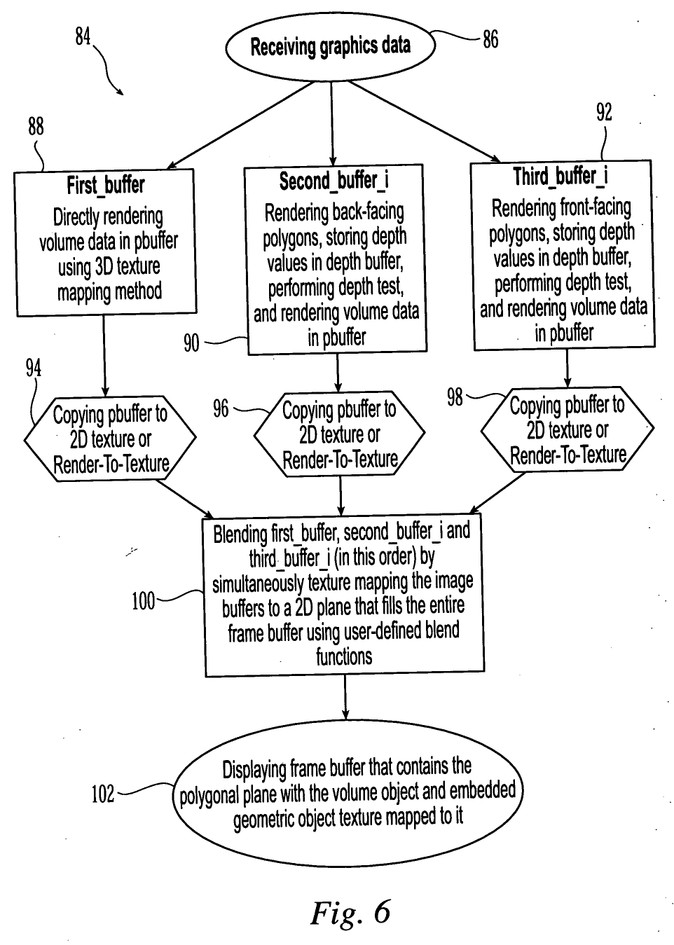

Referring to FIG. 6, an embodiment that implements a method in accordance with the present invention on commodity graphics hardware is illustrated 84. The commodity graphics hardware contains three off-screen pixel buffers, pbuffers, in the graphics card memory. Pbuffers enable off-screen rendering with Open Graphics Library, which is a 3D graphics language. In this embodiment, the three pbuffers are identified as the first buffer, the second buffer and the third buffer. The graphics data are received 86 for the objects contained within the composite image. Volume data for the first object are rendered and stored in the first buffer 88 located in the graphics card memory. The volume data are preferably rendered using 3D texture mapping or by 2D multi-texture extensions. The back-facing polygons of the second object in combination with the first object volume data are rendered and stored in the second buffer 90 located in the graphics memory card. In addition, depth values are stored in depth buffer, and a depth test is performed. The depth test is preferably enabled throughout rendering of any volume data with geometry so that contributions are excluded from regions of the volume behind the selected geometry. The front-facing polygons of the geometric object in combination with the first object volume data are rendered and stored in the third buffer 92 located in the graphics memory card. In addition, depth values are stored in a depth buffer, and a depth test is performed.

After the rendered images are created and stored, the data contained in each one of the three pbuffers are copied directly to corresponding 2D textures 94, 96, 98, which are also located on the graphics card memory. The composite image components in the first buffer, second buffer, and third buffer images are blended by simultaneously texture mapping the image buffers to a two-dimensional plane that fills the entire frame buffer using blending functions 100. The blending functions are determined by the user depending on a desired composite image. The resulting composite image in the frame buffer that contains the volume object and embedded geometric object is then displayed 102, for example on a computer monitor.

The method for creating the composite image in accordance with the present invention sustains interactivity on commodity graphics cards due to the fact that the volume data and polygonal information are stored directly on the card's memory and the storage buffers also reside on the card. Therefore, the need to go “off-card” for data is eliminated, significantly reducing the time needed to move data to and from the card, any delays that such movement might created and any additional conflict or resource contention with necessary data movement that might produce further delays, impacting frame rate.

In another embodiment, any or all of the storage buffers reside in the CPU's main memory as opposed to the commodity graphics card. In this method, all of the computations and renderings are performed entirely on the CPU as opposed to the graphics processing unit. Performing the computations on the CPU, however, reduces interactivity. Alternatively, the speed and interactivity are significantly increased by using graphics cards and application program interfaces that provide a render-to-texture function. If this capability is available, the first buffer, second buffer, and third buffer images do not need to be stored in pbuffers and can be rendered directly to textures, eliminating the step of copying the puffer to 2D texture and increasing performance.

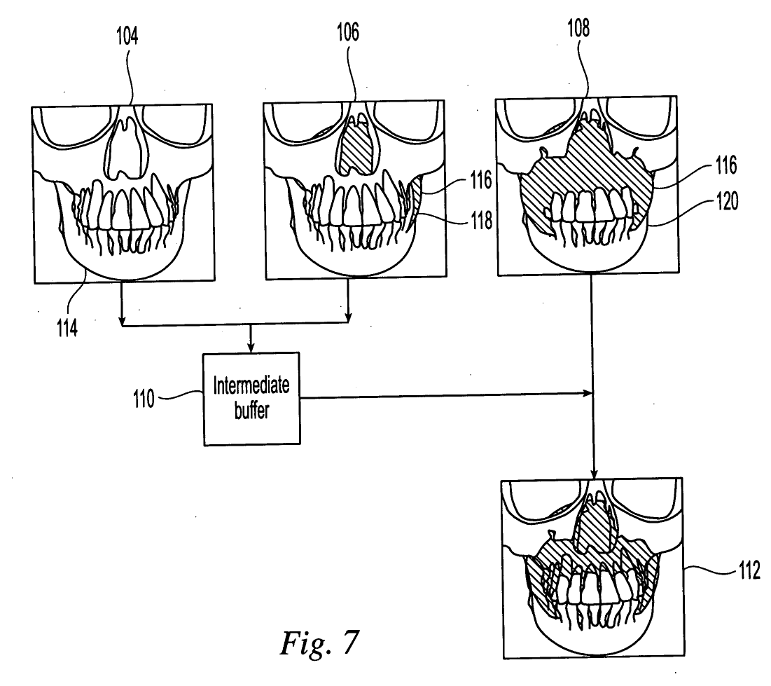

An example of an embodiment in accordance with the present invention is illustrated in FIG. 7. In this example as illustrated, the first object 114 is a human skull. The frame of reference for the first object 114 is a view from the front of the skull, and a volume image rendering of the first object 114 is obtained and stored in the first buffer 104. A single second object 116 is identified and for purposes of the example is selected to be a sphere centered in the interior region of the first object 114. A polygonal representation of the second object 116 is obtained and the back-facing polygons 118 of the polygonal representation are identified, rendered with the first object 114 and stored in the second buffer 106. Similarly, the front-facing polygons 120 are identified, rendered with the first object 114 and stored in the third buffer 108. The contents of the first and second buffers are blended and stored in an intermediate buffer 110. The content of the intermediate buffer 110 is then blended with the contents of the third buffer to produce the pre-defined composite image 112.

The present invention is also directed to a computer readable medium containing a computer executable code that when read by a computer causes the computer to perform a method for creating composite images in accordance with the present invention and to the computer executable code itself. The computer executable code can be stored on any suitable storage medium or database, including databases in communication with and accessible by the computer, CPU or commodity graphics card performing the method in accordance with the present invention. In addition, the computer executable code can be executed on any suitable hardware platform as are known and available in the art.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s). Therefore, it will be understood that the appended claims are intended to cover all such modifications and embodiments, which would come within the spirit and scope of the present invention.

What is claimed is

1. A method for creating composite images, the method comprising:
obtaining a volume rendered image of a first object;
generating at least a first geometric representation and a second geometric representation of a second object based upon a desired composite image of the first and second objects;
creating a plurality of composite image components, each composite image component comprising at least one of the volume rendered image, the first geometric representation and the second geometric representation; and
blending the plurality of composite image components to create the desired composite image.

2. The method of claim 1, wherein the first and second geometric representations comprise polygonal representations.

3. The method of claim 1, wherein the step of generating the first and second polygonal representations further comprises generating the representations based upon a user-defined frame of reference with respect to the desired composite image.

4. The method of claim 3, wherein the step of generating the first and second geometric representations comprises:
viewing the second object in a first view direction with respect to the user-defined frame of reference;
generating the first geometric representation based upon the first view direction;
viewing the second object in a second view direction substantially opposite the first view direction; and
generating the second geometric representation based upon the second view direction.

5. The method of claim 1, wherein the step of creating a plurality of composite image components comprises creating at least three distinct composite image components.

6. The method of claim 5, wherein the step of creating the three composite image components comprises:
creating a first composite image component comprising the volume rendered image;
creating a second composite image component comprising the volume rendered image and at least one of the first and second geometric representations; and
creating a third composite image component comprising the volume rendered image and at least one of the first and second geometric representations.

7. The method of claim 1, further comprising saving each one of the plurality of composite image components to a distinct storage buffer.

8. The method of claim 1, wherein the step of creating the plurality of composite image components comprises:
storing volume image depth values associated with the first object in a depth buffer, each volume image depth value associated with a distinct portion of the volume rendered image as viewed with respect to a user-defined frame of reference;
comparing geometric representation depth values associated with portions of the second object corresponding to portions of the volume rendered image in accordance with the user-defined frame of reference;
selecting second object portions to be included in the composite image components based upon a comparison of geometric representation depth values to volume image depth values; and
replacing volume image depth values associated with volume image portions corresponding to the selected second object portions with the geometric representation depth values.

9. The method of claim 1, wherein the step of blending the plurality of composite image components comprises:
storing geometric representation depth values associated with the second object in a read-only depth buffer, each geometric representation depth value associated with a distinct portion of at least one of the first geometric representation and the second geometric representation as viewed with respect to a user-defined frame of reference;
comparing volume image depth values associated with portions of the first object corresponding to portions of the second object to determine relative depths of corresponding portions of the first and second object in accordance with the user-defined frame of reference; and
blending the corresponding portions of the first and second objects in accordance with the relative depths and image qualities associated with at least one of the volume rendered image, the first geometric representation and the second geometric representation.

10. The method of claim 9, wherein the image qualities comprise transparency.

11. A computer readable medium containing a computer executable code that when read by a computer causes the computer to perform a method for creating composite images, the method comprising:
obtaining a volume rendered image of a first object;
generating at least a first geometric representation and a second geometric representation of a second object based upon a desired composite image of the first and second objects;
creating a plurality of composite image components, each composite image component comprising at least one of the volume rendered image, the first geometric representation and the second geometric representation; and
blending the plurality of composite image components to create the desired composite image.

12. The computer readable medium of claim 11, wherein the first and second geometric representations comprise polygonal representations.

13. The computer readable medium of claim 11, wherein the step of generating the first and second polygonal representations further comprises generating the representations based upon a user-defined frame of reference with respect to the desired composite image.

14. The computer readable medium of claim 13, wherein the step of generating the first and second geometric representations comprises:
viewing the second object in a first view direction with respect to the user-defined frame of reference;
generating the first geometric representation based upon the first view direction;
viewing the second object in a second view direction substantially opposite the first view direction; and
generating the second geometric representation based upon the second view direction.

15. The computer readable medium of claim 11, wherein the step of creating a plurality of composite image components comprises creating at least three distinct composite image components.

16. The computer readable medium of claim 15, wherein the step of creating the three composite image components comprises:
creating a first composite image component comprising the volume rendered image;
creating a second composite image component comprising the volume rendered image and at least one of the first and second geometric representations; and
creating a third composite image component comprising the volume rendered image and at least one of the first and second geometric representations.

17. The computer readable medium of claim 11, further comprising saving each one of the plurality of composite image components to a distinct storage buffer.

18. The computer readable medium of claim 11, wherein the step of creating the plurality of composite image components comprises:
storing volume image depth values associated with the first object in a depth buffer, each volume image depth value associated with a distinct portion of the volume rendered image as viewed with respect to a user-defined frame of reference;
comparing geometric representation depth values associated with portions of the second object corresponding to portions of the volume rendered image in accordance with the user-defined frame of reference;
selecting second object portions to be included in the composite image components based upon a comparison of geometric representation depth values to volume image depth values; and
replacing volume image depth values associated with volume image portions corresponding to the selected second object portions with the geometric representation depth values.

19. The computer readable medium of claim 11, wherein the step of blending the plurality of composite image components comprises:
storing geometric representation depth values associated with the second object in a read-only depth buffer, each geometric representation depth value associated with a distinct portion of at least one of the first geometric representation and the second geometric representation as viewed with respect to a user-defined frame of reference;
comparing volume image depth values associated with portions of the first object corresponding to portions of the second object to determine relative depths of corresponding portions of the first and second object in accordance with the user-defined frame of reference; and
blending the corresponding portions of the first and second objects in accordance with the relative depths and image qualities associated with at least one of the volume rendered image, the first geometric representation and the second geometric representation.

20. The computer readable medium of claim 19, wherein the image qualities comprise transparency.
